(19) United States
(12) Patent Application Publication
(10) Pub. No.: US 2004/0253051 A1
(43) Pub. Date: Dec. 16, 2004

(54) Connecting Device

(75) Inventor: Eckhard Napp, Bruggen (DE)

Correspondence Address: GUDRUN E. HUCKETT DRAUDT, LONSSTR. 53, WUPPERTAL, 42289, DE

(73) Assignee: ANTON HURTZ GMBH + CO. KG, Nettetal (DE)

(21) Appl. No.: 10/710,846

(22) Filed: Aug. 6, 2004

Related U.S. Application Data
(63) Continuation of application No. PCT/EP02/09445, filed on Aug. 23, 2002.

(51) Int. Cl. F16B 1/00

(52) U.S. Cl. 403/331

(57) ABSTRACT

A connecting device for first and second rods has a first profile provided on the first rod and a second profile provided on the second rod. The first and second profiles are joined in a connecting position along a partition line by being moved relative to one another in a direction of a degree of freedom predetermined by the first and second profiles. The first and second profiles are moved immediately before reaching the connecting position in the direction of the predetermined degree of freedom. The first and second profiles in the joined state define a cutout bridging the partition line. A locking bar matching the cross-section of the cutout is inserted into the cutout and provides a movability lock for locking a unit, formed of the first and second rods and the locking bar, in a locking direction opposite to the direction of the degree of freedom.

### CROSS REFERENCE TO RELATED APPLICATIONS

This application is a continuation application of international application PCT/EP02/09445 having an international filing date of Aug. 23, 2002, not published in English according to PCT Article 21(2), and still pending.

### BACKGROUND OF INVENTION

1. Field of the Invention

The invention relates to a connecting device, in particular, between a first bar and a second bar to be connected to one another. The first and second bars have at a connecting location two complementary positive and negative profiles that can be brought into their connecting position along a partition line with a predetermined degree of freedom.

2. Description of the Related Art

Such connecting devices are known in principle. They are usually in the form of tongue and groove connections where the bars to be connected are pushed together in this area. This connecting location must still be fastened; usually, this is done by adhesives, by welding seams, by screws or by rivets.

Producing such a connection requires therefore at least one tool so that the manufacturing costs for these connections are high. Moreover, in the case of special connections, for example, welded or riveted connections, the customer cannot carry out the necessary work. Therefore, such a connection must be produced already at the manufacturing site. This leads to high transportation costs in the case of bar or rod constructions having large sizes.

### SUMMARY OF INVENTION

It is therefore an object of the present invention to provide a connecting device of the aforementioned kind that provides always a fixed and stable connection with technically simple means and can be joined without any auxiliary means.

In accordance with the present invention, this is achieved for a connecting device of the aforementioned kind in that a separate locking bar is provided that extends on both sides of the partition line between the first profile and the second profile, wherein the bars or rods together with the locking bar form a unit of three components, wherein a movability lock is provided by the locking bar between the three components in a locking direction that is opposite to the direction of the degree of freedom of the profiles immediately before reaching the connecting position, wherein the shapes of the first profile and of the second profile in the combined state define a cutout matching the cross-sectional shape of the locking bar, wherein the cutout bridges the partition line.

This connecting device according to the invention can be handled very easily because only the first and second profiles must be combined in the direction mandated by the profile shape. Accordingly, when these profiles of the rod ends are joined, it is only necessary to insert the corresponding locking bar into the now formed cutout. This task is very simple and does not require any tools.

As a result of the initial joining of the first and second profiles, initially a positive-locking action results. A non-positive securing action is provided only after insertion of the locking bar.

According to an advantageous embodiment of the invention, it is provided that the first and the second profiles engage mutually at least one undercut of the other profile. The shaping of the two profiles ensures thus already a certain securing action.

However, it is also possible that the locking bar in the joined state engages undercuts of the first and second profiles. In this situation, only after the locking bar has been inserted, a detachment of the two bars in the longitudinal direction of the bars is prevented.

A particularly stable connection is provided when the first and second profiles as well as the locking bar engage undercuts of the profiles.

For preventing movement in the direction of the last degree of freedom before the final joining step, it is sufficient when the longitudinal axis of the locking bar extends perpendicularly to the direction of this degree of freedom. This provides already a very stable connection with regard to tension load along the longitudinal axis of the rods.

Perpendicularly to these longitudinal axes of the rods, the connection can still be released by relative movement of the parts. In order to prevent this, it is advantageous when the longitudinal axis of the locking bar extends at a slant to the direction of the degree of freedom. Also, the locking bar can be designed to be screwable into the cutout.

The connections discussed above concern generally connections along the longitudinal axis of the rods or bars to be combined. However, it is also possible that the rods or bars are to be joined at an obtuse angle, a right angle or an acute angle relative to one another.

According to an advantageous further embodiment, it is provided that at least four rods provided with the inventive first and second profiles at both ends are connected to a frame. As a result of the simple connection according to the invention, these four rods can be transported in the demounted state, thus requiring only minimal space, and can be mounted at the final destination.

This holds true particularly when such frames are large. For some applications, frames are required whose long side has a length of approximately 7 meters. The shorter sides have approximately a length of 3.5 meters. A frame having these dimensions would require a very large and thus very expensive transportation space. This transportation space can now be minimized according to the invention because the individual frame sides (rods) can be transported while being stacked on top one another.

At the final destination (the site of use), these individual frame sides are joined and the matching locking bars are then inserted into each corner of the frame.

As needed, the inserted locking bar can be removable or fixed (non-releasable). This holds true also for all other connections mentioned above.

According to a further embodiment, it is provided that the locking bar in cross-section has a rectangular shape, a circular shape, a diamond shape, a figure eight shape, a dovetail shape, an elliptical shape or a cross shape.

When the rods to be connected are to have a minimal weight but still a high strength, it is advantageous when the rods are hollow rods or bars and are provided with reinforcements that adjoin the area of the connections.

It is particularly advantageous when the reinforcements are hollow rods or solid rods matched to the hollow interior of the bars or rods to be connected. The reinforcements fully contact the inner surfaces of the rods to be connected or at least along two lines in the longitudinal direction, wherein the reinforcements are arranged either along the entire length of the rod or along a portion of the length of the rod.

Usually, the first and second profiles are produced with different tools, in particular, forming or shaping tools or molds, such that the profiles in the joined state substantially complement one another. A particularly advantageous embodiment with respect to reducing costs with regard to manufacturing as well as storing resides in that the first profiles and the second profiles in the joined state have rotation symmetry in cross-section. Such profiles can be produced by the same tool, in particular, the same shaping or forming tool or mold. When the rods are stacked on top one another, the end faces have identical profiles. In order to be able to insert these first and second profiles into one another, a first rod resting on a second rod must only be rotated by 180 degrees and inserted into the matching profile of the second rod.

It is advantageous when the components are made of metal, wood, or plastic material or of a combination of at least two material types. Of course, other materials can also be used.

Further advantages and features of the invention result from the following description of several embodiments as well as the drawings to which reference is being had.

### BRIEF DESCRIPTION OF DRAWINGS

FIG. 1a shows in an end view a first embodiment of complementary profiles of rods to be joined.

FIG. 1b shows an end view of the joined profiles of FIG. 1a with locking bar inserted into the cutout.

FIG. 2a shows an end view of complementary profiles of rods to be joined of a second embodiment.

FIG. 2b shows an end view of the joined profiles of FIG. 2a with inserted locking bar.

FIG. 3a shows an end view of complementary profiles of rods to be joined of a third embodiment.

FIG. 3b shows an end view of the joined profiles of FIG. 3a with inserted locking bar.

FIG. 4a shows an end view of complementary profiles of rods to be joined of a fourth embodiment.

FIG. 4b shows an end view of the joined profiles of FIG. 4a with inserted locking bar.

FIG. 5a shows an end view of complementary profiles of rods to be joined of a fifth embodiment.

FIG. 5b shows an end view of the joined profiles of FIG. 5a with inserted locking bar.

FIG. 6a shows an end view of complementary profiles of rods to be joined of a sixth embodiment.

FIG. 6b shows an end view of the joined profiles of FIG. 6a with inserted locking bar.

FIG. 7a shows an end view of complementary profiles of rods to be joined of a seventh embodiment.

FIG. 7b shows an end view of the joined profiles of FIG. 7a with inserted locking bar.

FIG. 8a shows an end view of complementary profiles of rods to be joined of a eight embodiment.

FIG. 8b shows an end view of the joined profiles of FIG. 8a with inserted locking bar.

FIG. 9a shows an end view of complementary profiles of rods to be joined of a ninth embodiment.

FIG. 9b shows an end view of the joined profiles of FIG. 9a with inserted locking bar.

in the FIG. 10a shows an end view of complementary profiles of rods to be joined of a tenth embodiment.

FIG. 10b shows an end view of the joined profiles of FIG. 10a with inserted locking bar.

FIG. 11a shows an end view of complementary profiles of rods to be joined of a eleventh embodiment.

FIG. 11b shows an end view of the joined profiles of FIG. 11a with inserted locking bar.

FIG. 12a shows an end view of complementary profiles of rods to be joined of a sixth embodiment.

FIG. 12b shows an end view of the joined profiles of FIG. 12a with inserted locking bar.

FIG. 13a shows an end view of complementary profiles of rods to be joined of a thirteenth embodiment.

FIG. 13b shows an end view of the joined profiles of FIG. 13a with inserted locking bar.

FIG. 14a shows an end view of complementary profiles of rods to be joined of a fourteenth embodiment.

FIG. 14b shows an end view of the joined profiles of FIG. 14a with inserted locking bar.

FIG. 15a shows an end view of complementary profiles of rods to be joined of a fifteenth embodiment.

FIG. 15b shows an end view of the joined profiles of FIG. 15a with inserted locking bar.

FIG. 16a shows a frame comprised of four bars.

FIG. 16b is a section taken along the line XVIb-XVIb of FIG. 16a.

FIG. 16c shows detail D of FIG. 16b.

FIG. 17a shows a locking bar in dashed lines inside two connected rods, wherein the locking bar extends at a slant to the degree of freedom of the rods.

FIG. 17b shows a section of the connected rods and the locking bar taken along the section line XVIIb-XVIIb in FIG. 17a.

FIG. 18a is a section view of connected hollow rods having reinforcements inserted into the ends of the hollow rods at the connecting location.

FIG. 18b is a view onto the connected rods in the direction of arrow XVIIIb.

### DETAILED DESCRIPTION

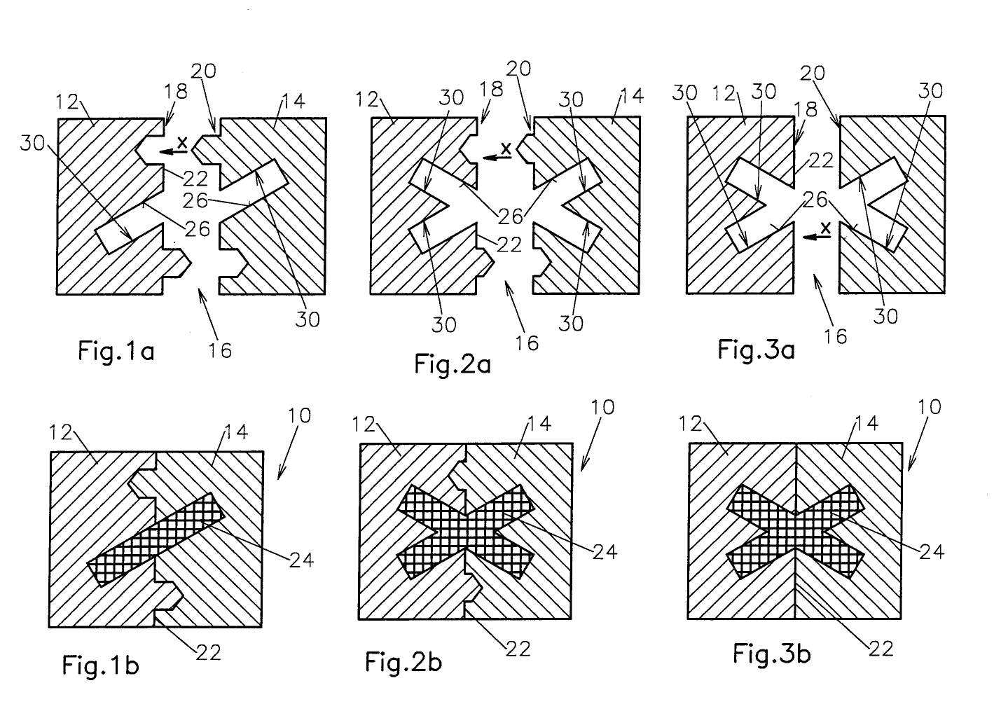

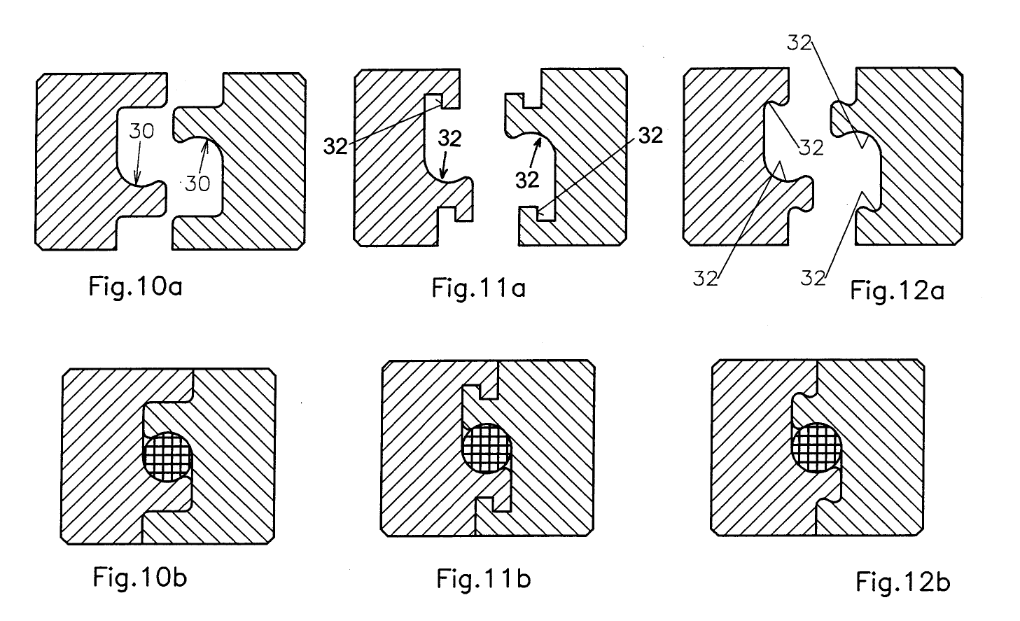

With the aid of FIGS. 1a, 1b through 18a, 18b exemplary embodiments will be described. It will be apparent to a person skilled in the art that there are many more possibilities and variations particularly of the profiles for realizing the connecting device.

For reasons of simplification, despite the differently shaped profiles in the illustrated embodiments, the same reference numerals are used for parts functioning in the same way.

In the Figures, the connecting devices 10 according to the invention are shown for combining first and second rods 12 and 14.

These rods 12, 14 are joined with one another at a connecting location 16. For this purpose, the rods 12 and 14 are provided with substantially complementary first profiles 18 and second profiles 20 which can be moved along a partition line 22 with a predetermined degree of freedom X into their connecting position. This degree of freedom X defines the last movement direction for reaching a positive-locking connection between the first profile 18 and the second profile 20. Even though the Figures illustrate the degree of freedom X only by a single orientation of the arrow X, it is understood that the opposite direction can be used as well for producing the connection. This degree of freedom X can be linear, as indicated in the drawings but also non-linear, for example, can follow a circular or curved movement.

For explaining the device, it is supposed that in the Figures the first rod 12 remains at rest and the second rod 14 is moved for producing the connection with the first rod 12.

When the two rods 12 and 14 are moved into their connecting position, a separate locking bar 24 can be inserted into the cutout 26. The locking bar 24 is illustrated in the drawings with crosshatching to make it easily visually distinguishable from the rods.

This cutout 26 is determined by the shape of the first profile 18 and of the second profile 20 in the joined state of the rods. The cross-section of the cutout matches the cross-sectional profile of the locking bar 24.

The separate locking bar 24 extends on both sides of the partition line 22 between the first profile 18 and the second profile 20. The rods 12 and 14 together with the locking bar 24 form a unit of three components; a mobility lock for the unit of the three components is provided by means of the locking bar 24 that upon insertion locks the three components in a direction perpendicular to the direction of the degree of freedom X immediately before reaching the connecting position.

By joining the two rods 12 and 14, initially a positive-locking action can result due to the profiles of the rods, as shown in FIGS. 1, 2, 5, 6, 8, 9, 10, 11, 12, 13, 14, 15. However, only after the introduction of the locking bar 24 a nonpositive locking action is provided.

For realizing the initial positive locking action and the final nonpositive locking action, there are three possibilities. Firstly, the first profile 18 and the second profile 20 can be profiled such that they mutually engage at least one undercut 28 of the other profile. This type of engagement with undercuts 28 is illustrated in the drawings FIGS. 8, 9, 14 and 15.

Another possibility resides in that it is the locking bar 24 that in the joined state engages undercuts 30. This type of engagement with undercuts 30 are illustrated in FIGS. 1 through 5, 7, and 10.

Finally, there is also the possibility of a combination of both undercut types. This is realized when the first profile 18 and the second profile 20 as well as the locking bar 24 engage undercuts 32. This is realized in the embodiments of FIGS. 6, 11, 12, and 13.

A possibility for the extension/orientation of the locking bar 24 resides in that the longitudinal axis of the locking bar 24 extends perpendicularly to the direction of the degree of freedom X. Accordingly, it extends perpendicularly to the plane of the drawings of FIGS. 1 through 15.

This still allows the three components of the connecting device 10 to move in the direction perpendicularly to the plane of the drawing; therefore, the three components of the unit are still releasable.

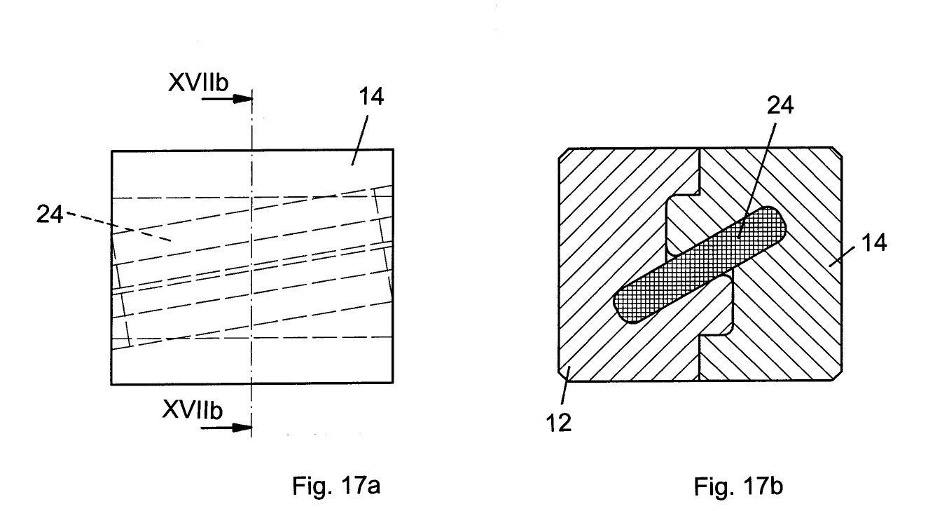

If this is not desirable, this can be counteracted in that the longitudinal axis of the locking bar 24 extends at a slant relative to the direction of the degree of freedom X (FIG. 17a). The locking bar 24 then extends at a slant to the normal of the plane of the drawing (FIG. 17b).

In the first possibility, the locking bar therefore is uniaxially angled while in the second possibility it is biaxially angled.

Connections of rods 12 and 14 have been described above where the longitudinal axes of the rods 12 and 14 coincide. However, it is also possible that the rods 12 and 14 are positioned at an obtuse, a right, or an acute angle to one another for being connected.

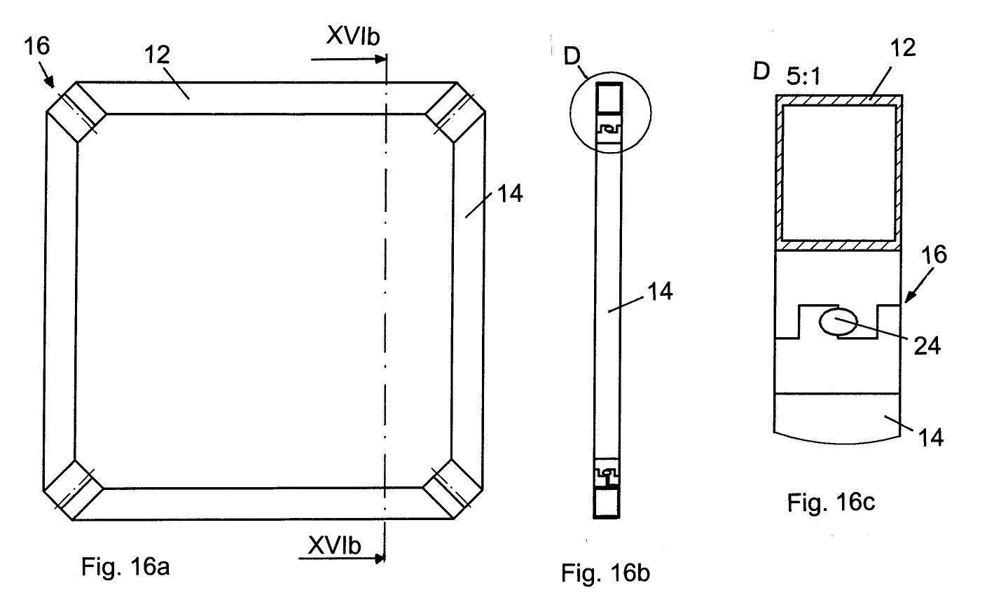

The most frequently employed angle will be, however, a right angle in order to form by means of the rods 12 and 14 and the connecting device a quadrangular frame (FIGS. 16a, 16b, 16c).

This is particularly of interest when the frame is large. For example, frames are known which have sides of a length of approximately 7 meters by 3.5 meters. In the past, it was conventional to transport or ship such frames in the finish-mounted state or to combine the frame parts at the final destination by means of tools, for example, welding tools.

With the present invention it is now possible to ship such frames in the demounted state so that the transport costs are low. In comparison to the prior art, only small packages are to be shipped. At the final destination (site of use), the corresponding rods 12 and 14 are then joined such that the first profile 18 and second profile 20 engage one another. Subsequently, it is only necessary to insert the locking bar 24 at each corner. Of course, it is also possible to construct other spatial or three-dimensional configurations in this way.

The inserted locking bar 24 can be detachably arranged within the cutout 26. However, it is also possible to non-detachably secure the locking bar 24 in its position with proper means.

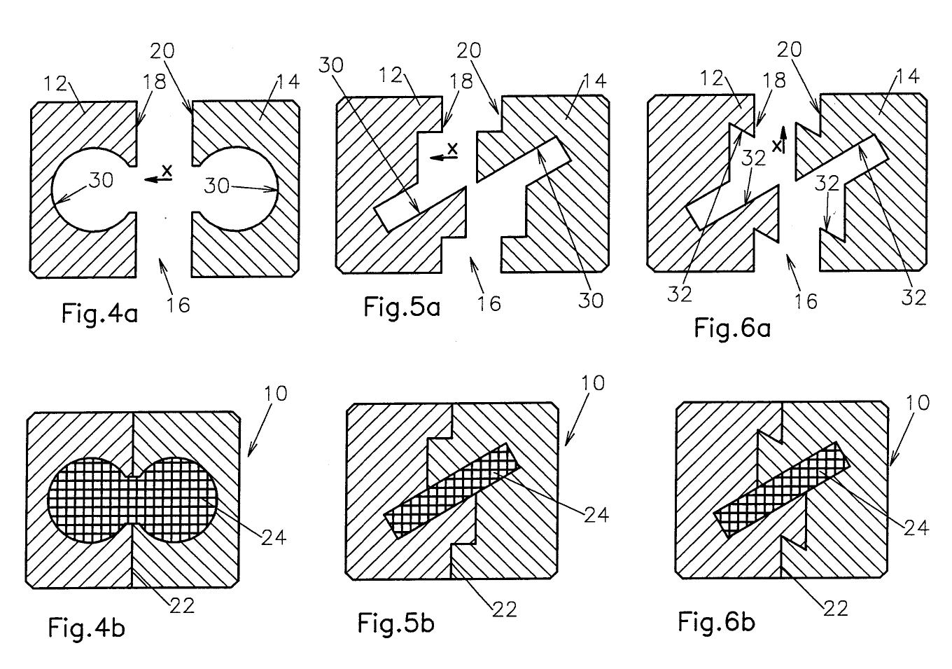

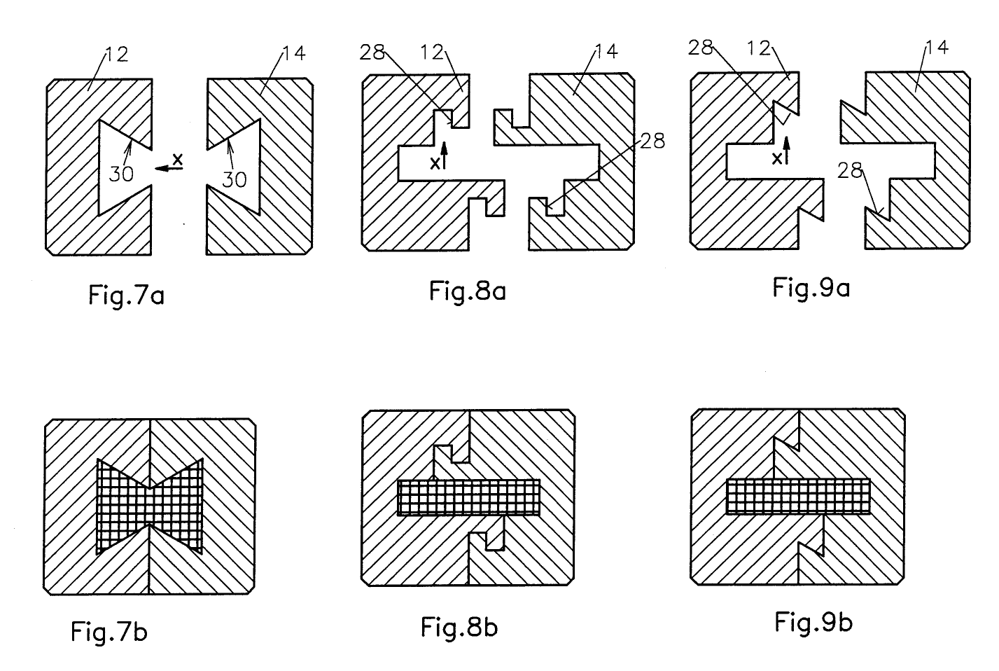

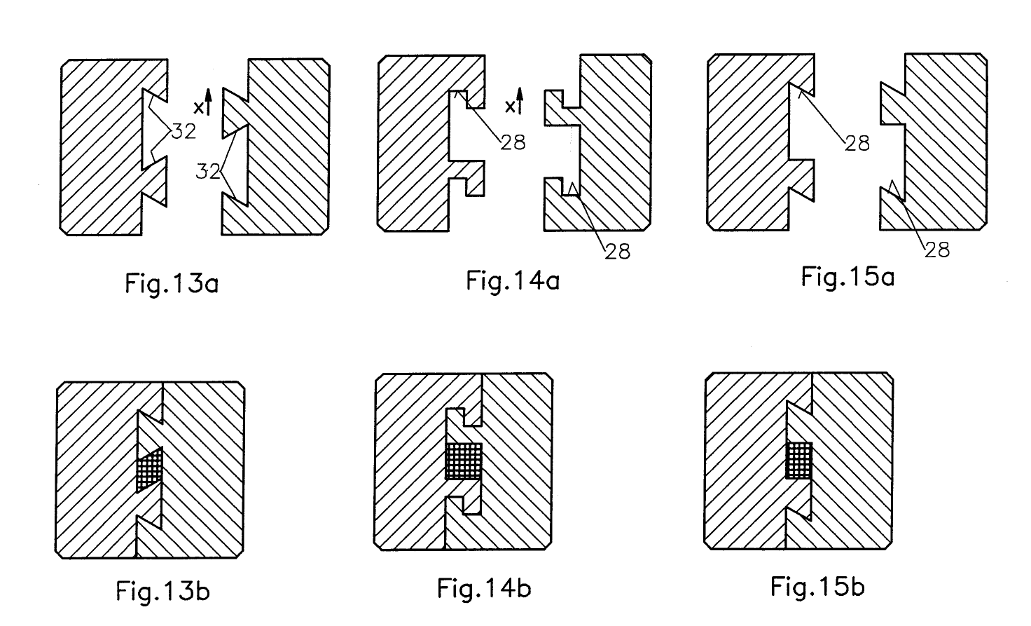

Various configurations of the cross-section of the locking bar 24 are possible. For example, the locking bar 24 can have in cross-section a rectangular shape (see FIGS. 1, 5, 6, 8, 9, 14, 15), a diamond shape (see FIG. 13), a figure eight shape (see FIG. 4), a dovetail shape (see FIG. 7), a circular shape (see FIGS. 10 through 12), an elliptical shape, or a cross shape (see FIGS. 2 and 3).

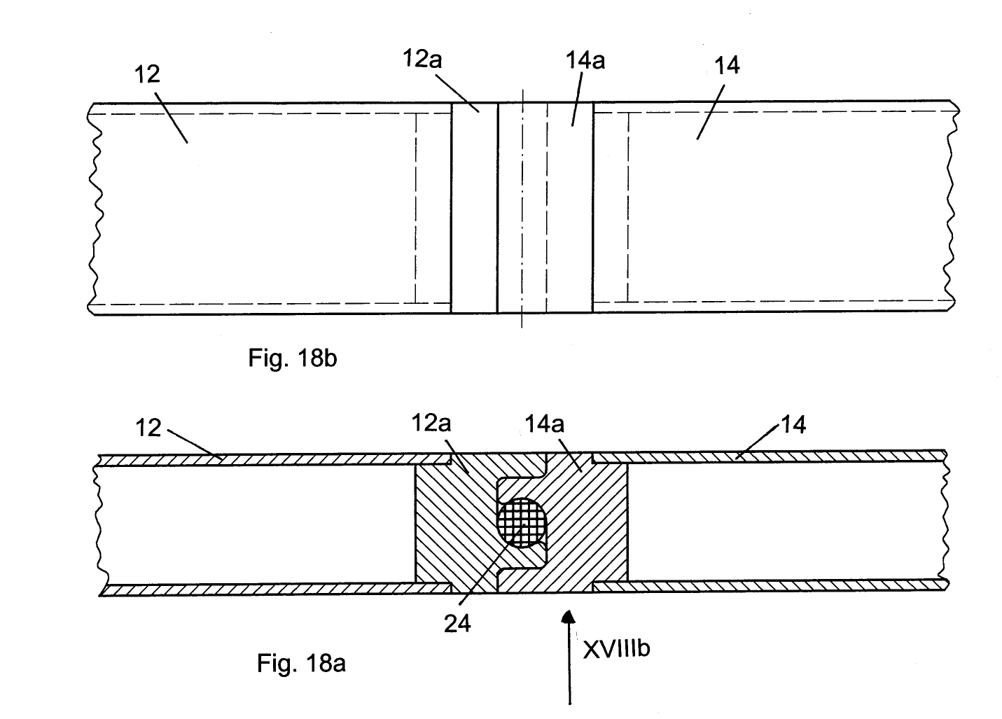

When for reasons of weight reduction the rods 12, 14 are hollow rods, but the connection, in particular, the rods 12, 14 still require a certain stability and strength, it is possible to provide on or in the rods 12, 14 reinforcements 12a, 14a in the vicinity of the connections (FIGS. 18a, 18b). In this connection, it is possible that the reinforcements are hollow or solid rods matched to the hollow interior of the rods 12 and 14. The cross-sectional shape of the matched hollow or solid rods can be selected such that the matched hollow and solid rods will fully contact the inner surface of the rods 12 and 14 over the entire surface area or along at least two lines in the longitudinal direction, wherein the reinforcements are arranged either along the entire rod length or along a portion of the rod length. In this way, in particular in the case of the already mentioned large frames an enormous torsional stiffness and flexural strength can be provided.

All of the embodiments have in common that the first profile 18 and second profile 20 in the joined state have rotation symmetry in cross-section. This means that the two profiles are identical when stacked on top one another. This reduces the manufacturing and storage costs. However, it is also possible to employ asymmetrical profiles.

Many types of material can be employed; however, metal, wood, or plastic material or a combination of at least two of these materials is preferred.

While specific embodiments of the invention have been shown and described in detail to illustrate the inventive principles, it will be understood that the invention may be embodied otherwise without departing from such principles.

What is claimed is:

1. A connecting device for a first rod and a second rod to be connected to one another, the connecting device comprising:
a first profile provided on the first rod and a second profile provided at the second rod, wherein the first and second profiles are configured to be joined in a connecting position along a partition line by being moved relative to one another in a direction of a predetermined degree of freedom, predetermined by the first profile and the second profile, wherein the first and second profiles are moved immediately before reaching the connecting position in the direction of the predetermined degree of freedom;
wherein the first profile and the second profile in the joined state define a cutout bridging the partition line and extending on both sides of the partition line;
a separate locking bar having a cross-sectional shape matching a cross-section of the cutout;
wherein the first and second rods and the locking bar form a unit of three components, wherein the locking bar is inserted into the cutout and provides a movability lock between the three components of the unit in a locking direction opposite to the direction of the predetermined degree of freedom immediately before reaching the connecting position.

2. The connecting device according to claim 1, wherein the first and second profiles each have at least one undercut and wherein the first and second profiles engage one another in the connecting position by mutually engaging the at least one undercut.

3. The connecting device according to claim 1, wherein the first and second profiles each have at least one undercut and wherein the locking bar engages the at least one undercut of the first and second profiles.

4. The connecting device according to claim 1, wherein the first and second profiles each have at least one first undercut and at least one second undercut, wherein the first and second profiles engage one another by mutually engaging the at least one first undercut, and wherein the locking bar engages the at least one second undercut, respectively.

5. The connecting device according to claim 1, wherein a longitudinal axis of the locking bar extends perpendicularly to the direction of the predetermined degree of freedom.

6. The connecting device according to claim 1, wherein a longitudinal axis of the locking bar extends at a slant to the direction of the predetermined degree of freedom.

7. The connecting device according to claim 1, wherein the first and second rods are joined at an acute angle, an obtuse angle or a right angle relative to one another.

8. The connecting device according to claim 7, wherein at least four of the first and second rods are joined to form a frame.

9. The connecting device according to claim 1, wherein the locking bar is removable from the cutout.

10. The connecting device according to claim 1, wherein the locking bar is non-releasable once inserted into the cutout.

11. The connecting device according to claim 1, wherein the locking bar has a cross-section selected from the group consisting of a rectangular shape, a circular shape, a diamond shape, a figure eight shape, a dovetail shape, an elliptical shape, and a cross shape.

12. The connecting device according to claim 1, wherein the first and second rods are hollow and comprise reinforcements arranged near the connecting location.

13. The connecting device according to claim 12, wherein the reinforcements are hollow rods or solid rods matched to a hollow interior of the first and second rods, wherein the reinforcements fully contact an inner surfaces of the first and second rods or contact the inner surface at least along two lines in a longitudinal direction of the hollow interior, wherein the reinforcements are arranged across an entire length of the first and second rods or across a portion of the entire length of the first and second rods.

14. The connecting device according to claim 1, wherein the first and second profiles in the joined state have rotation symmetry.

15. The connecting device according to claim 1, wherein first and second rods and the locking bar are made of at least one of the materials selected from the group consisting of metal, wood, and plastic material.
